(19) United States
(12) Patent Application Publication
(10) Pub. No.: US 2020/0079632 A1
(43) Pub. Date: Mar. 12, 2020

(54) BELOW GRADE ACCESS PLATFORM

(71) Applicant: JLG Industries, Inc., McConnellsburg, PA (US)

(72) Inventor: Peter D. Gilbert, Stephens City, VA (US)

(21) Appl. No.: 16/568,304

(22) Filed: Sep. 12, 2019

Related U.S. Application Data
(60) Provisional application No. 62/730,056, filed on Sep. 12, 2018.

(51) Int. Cl. B66F 11/04

(52) U.S. Cl. CPC B66F 11/046

(57) ABSTRACT

A below grade access platform machine includes a chassis, a turntable mounted on the chassis, a tower boom pivotably coupled with the turntable, and a mast boom assembly coupled with the tower boom. The mast boom assembly includes a mast mounting bracket coupled pivotably to the tower boom and a mast boom displaceable vertically in the mast mounting bracket. A platform coupled with the mast boom is displaceable with the mast boom between a level position essentially level with the chassis and a lowered position below the chassis.

### CROSS-REFERENCES TO RELATED APPLICATIONS

This application claims the benefit of U.S. Provisional Patent Application No. 62/730,056, filed Sep. 12, 2018, the entire content of which is herein incorporated by reference.

### STATEMENT REGARDING FEDERALLY SPONSORED RESEARCH OR DEVELOPMENT

(Not Applicable)

### BACKGROUND

Existing low level access products are designed with the goal of providing a safer and more productive alternative to scaffolding and ladders. While the demand for these products is increasing, one market where ladders are still common remains unaddressed—one where workers descend below grade to perform their jobs. Not only do these workers often descend depths greater than are serviced by existing low level access product lines, they also are working in conditions that can be wet, making ladder use even less safe. As America's water delivery and discharge systems continue to age, parts of which date back to the 1800's, the quantity of work that is to be done repairing and upgrading this infrastructure will only increase.

### SUMMARY

A product line of below grade access products will help these municipal and utility workers to complete their work in a safer and more productive manner. These products can also be equipped with accessories that will make work below grade safer and more efficient.

In an exemplary embodiment, a below grade access platform machine includes a chassis, a turntable mounted on the chassis, a tower boom pivotably coupled with the turntable, and a mast boom assembly coupled with the tower boom. The mast boom assembly includes a mast mounting bracket coupled pivotably to the tower boom and a mast boom displaceable vertically in the mast mounting bracket. A platform coupled with the mast boom is displaceable with the mast boom between a level position essentially level with the chassis and a lowered position below the chassis.

The mast boom may be telescopic. The mast boom may include a base section connected and displaceable relative to the mast mounting bracket and at least one telescoping section, where the platform may be coupled with the telescoping section. The tower boom may be telescopic. In this context, the tower boom may include a home section pivotably coupled with the turntable and an extension section, where the mast boom assembly may be coupled with the extension section. The turntable may be mounted for rotation on the chassis and may be rotatable through 360° on the chassis. The mast boom assembly may be pivotable relative to the tower boom via the mast mounting bracket into a shipping position in which the mast boom is essentially parallel to the tower boom and overlays the tower boom. The machine may further include a lift cylinder connected between the turntable and the tower boom, the lift cylinder effecting pivoting of the tower boom relative to the turntable between a shipping position and raised position.

In some embodiments, the tower boom may include a scissor assembly or an articulating boom.

In another exemplary embodiment, a below grade access platform machine includes a chassis, a turntable mounted for rotation on the chassis, and a tower boom pivotably coupled with the turntable. The tower boom is pivotable between a shipping position oriented below horizontal to a raised position oriented above horizontal. The tower boom is linearly extendable. A mast boom assembly coupled with the tower boom includes a mast mounting bracket coupled pivotably to the tower boom and a mast boom displaceable vertically in the mast mounting bracket. The mast boom is telescopic. A platform coupled with the mast boom is displaceable with the mast boom to a lowered position below the chassis.

### BRIEF DESCRIPTION OF THE DRAWINGS

These and other aspects and advantages will be described in detail with reference to the accompanying drawings, in which:

FIG. 1 is a side view of the below grade access platform machine according to the described embodiments;

FIG. 2 shows an exemplary leveling actuator for pivoting the mast boom relative to the tower boom;

FIG. 3 shows the below grade access platform machine with the tower boom extended;

FIG. 4 shows the tower boom positioned in a raised position via a lift cylinder;

FIGS. 5 and 6 show alternative positioning configurations of the below grade access platform machine;

FIG. 7 shows the below grade access platform machine with the tower boom in a raised position;

FIG. 8 shows the below grade access platform machine in a shipping position;

FIG. 9 is a perspective view of an exemplary platform connector;

FIGS. 10 and 11 show variations of the tower boom; and

FIGS. 12A and 12B illustrate dimensions for design objectives.

### DETAILED DESCRIPTION

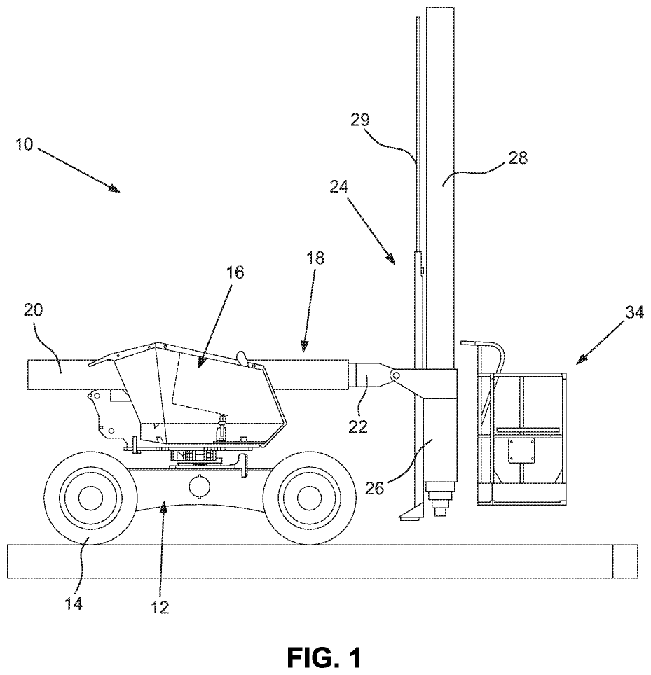

With reference to FIG. 1, a below grade access platform machine 10 includes a chassis 12 on which wheels 14 are secured. Wheels 14 are exemplary and other forms of transport such as continuous tracks or the like may be suitable. A suitable drive control system is associated with vehicle drive. A turntable/base unit 16 is mounted for rotation on the chassis 12. The manner in which the turntable/base unit 16 is secured to the chassis 12 and is rotatable relative to the chassis 12 is known, and details will not be described. In some embodiments, the turntable/base unit 16 is rotatable through 360° on the chassis 12. Alternatively, the turntable/base unit 16 may be fixed relative to the chassis 12.

A tower boom 18 is pivotably coupled with the turntable 16. In some embodiments, the tower boom 18 is telescopic and includes a home section 20 pivotably coupled directly with the turntable 16 and an extension section 22 that is linearly extendable relative to the home section 20. The tower boom 18 may include multiple telescoping extension sections 22. It is known that trench shoring may only be able to hold back certain ground loads near the trench. The telescopic tower boom 18 moves the weight of the chassis back from the edge of the trench. Extension and retraction of the extension section(s) 22 can be effected in any suitable known manner using cables, hydraulic actuators, or the like.

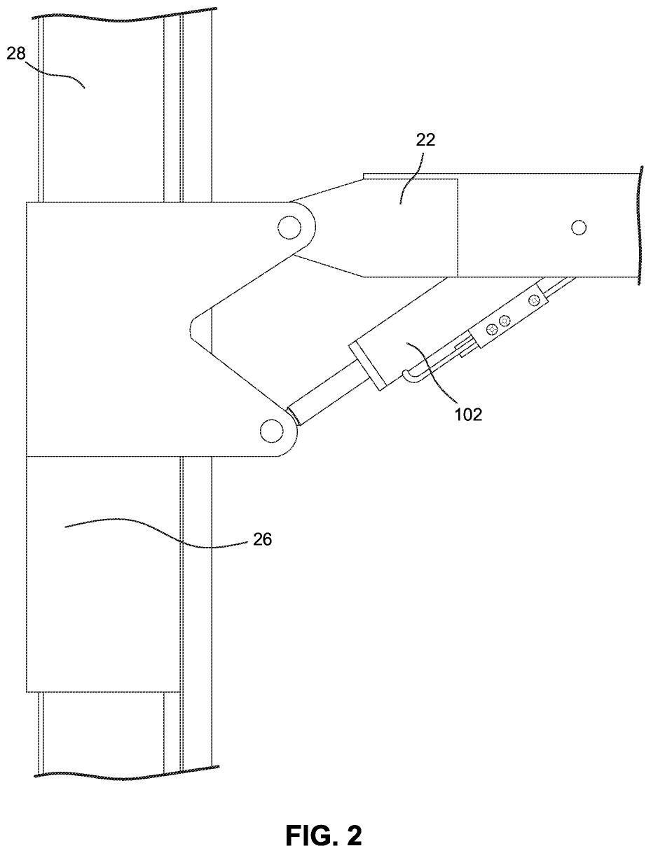

The machine 10 also includes a mast boom assembly 24 pivotably coupled with the tower boom 18. As shown, the mast boom assembly 24 is more specifically pivotably coupled with the forwardmost extension section 22 of the tower boom 18. The mast boom assembly 24 includes a mast mounting bracket 26 coupled pivotably to the tower boom 18 and a mast boom 28 displaceable vertically in the mast mounting bracket 26 via a suitable extension system 29. With reference to FIG. 2, in an exemplary arrangement, a leveling actuator 102 is connected between the mast mounting bracket 26 and the forwardmost extension section 22 of the tower boom 18. The leveling actuator 102 functions the same as existing platform leveling circuits either through a master-slave hydraulic circuit or with electronic leveling.

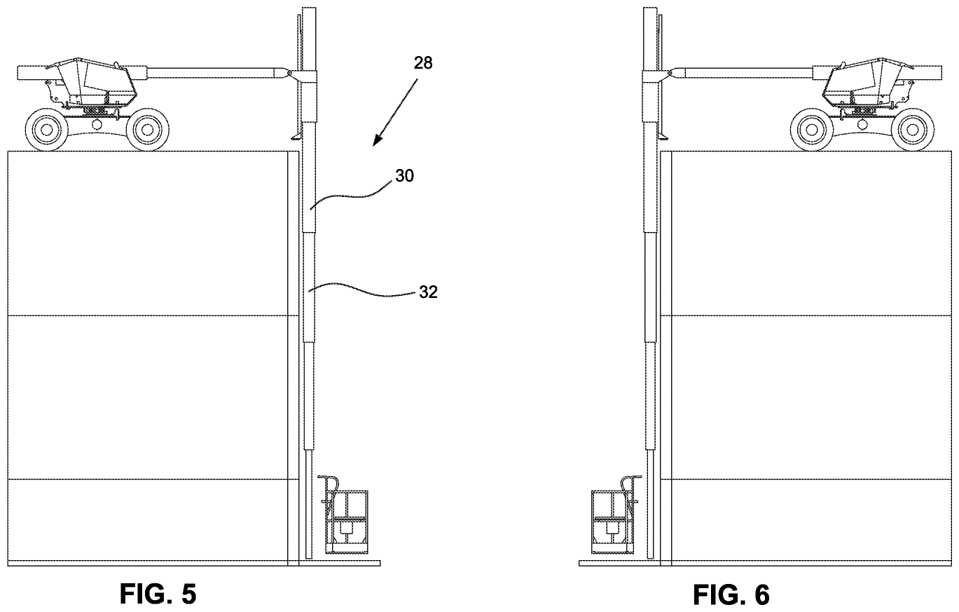

In some embodiments, the mast boom 28 is telescopic and includes a base section 30 that is connected and displaceable relative to the mast mounting bracket 26 and at least one telescoping section 32 (three telescoping sections 32 are shown in FIGS. 5-7). In some embodiments, cables may be used for extension and retraction of the mast boom. Depending on the size of the sheaves, chains may alternatively be used. Some of the sheaves may be moved to the rear side of the mast boom assembly 24 for packaging.

The drive control system is also configured to control positioning and expansion/retraction of the tower boom and mast boom.

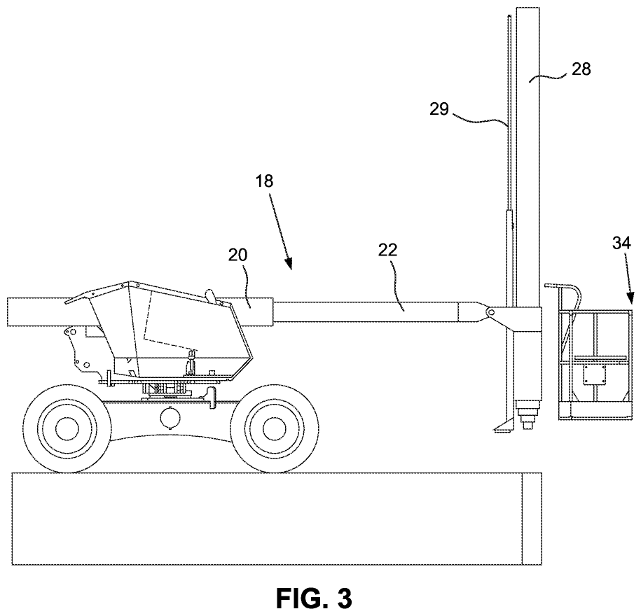

A platform 34 is coupled with the mast boom 28 and is displaceable with the mast boom 28 between a level position essentially level with the chassis 12 (FIGS. 1 and 3) and a lowered position below the chassis 12 (FIGS. 5-7).

In the position shown in FIG. 1, the mast boom 28 is fully retracted and is oriented substantially perpendicular to the tower boom 18. The tower boom 18 is also fully retracted. The configuration shown in FIG. 1 is a normal transport position for driving the machine around a worksite. In FIG. 3, the tower boom 18 is extended, and the mast boom 28 remains essentially perpendicular to the tower boom 18 and is in a fully retracted position. Machine drive is permitted in this position, but may be limited with regard to speed. Because the turntable 16 is rotatable through 360° on the chassis 12, the chassis 12 may be oriented parallel to the trench or the like, enabling the operator to traverse the machine between descent location (see e.g., FIG. 6). In the positions as shown in FIGS. 5 and 6, the tower boom 18 and mast boom 28 are fully extended. Vehicle drive may be prohibited in this position.

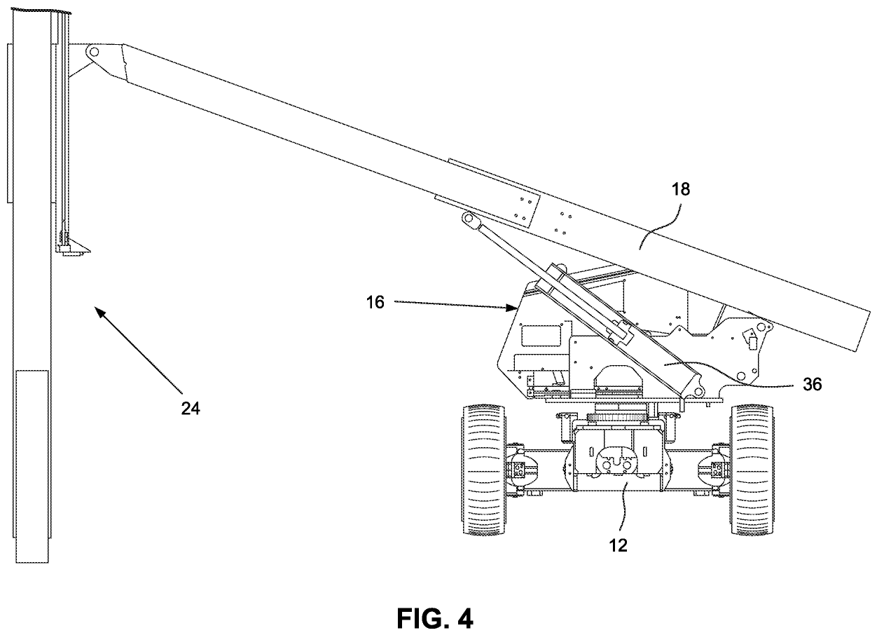

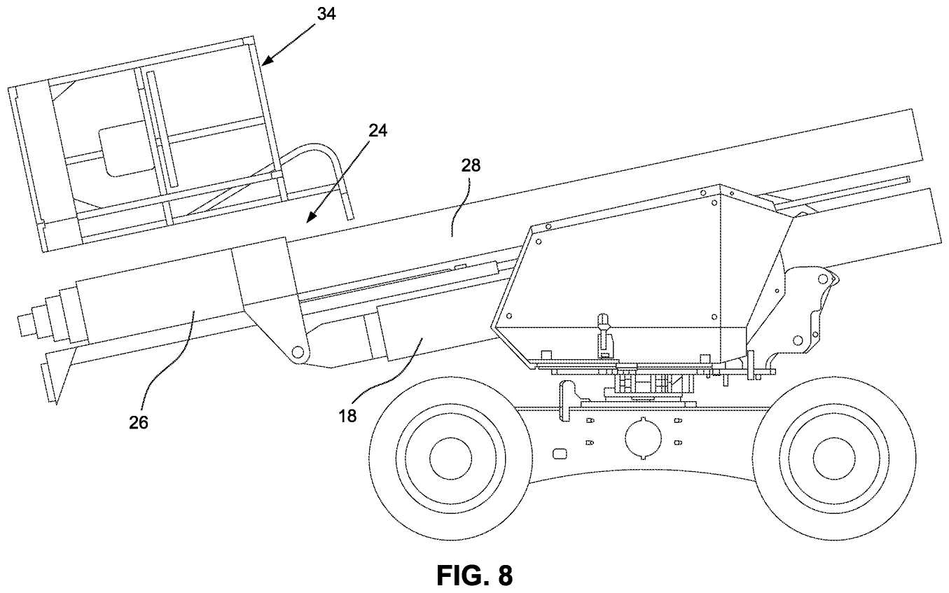

With reference to FIG. 4, a lift cylinder 36 such as a hydraulic cylinder or the like is connected between the turntable 16 and the tower boom 18. The lift cylinder 36 effects pivoting of the tower boom 18 relative to the turntable 16 between a raised position (FIG. 4) in which the tower boom is angled/oriented above horizontal and a shipping position (FIG. 8) in which the tower boom 18 is angled/oriented below horizontal. In the shipping position shown in FIG. 8, the mast boom assembly 24 is pivoted relative to the tower boom 18 via the mast mounting bracket 26 such that the mast boom 28 is essentially parallel to the tower boom 18 and overlays the tower boom 18. The platform 34 in the shipping position may be secured on top of the mast boom assembly 24.

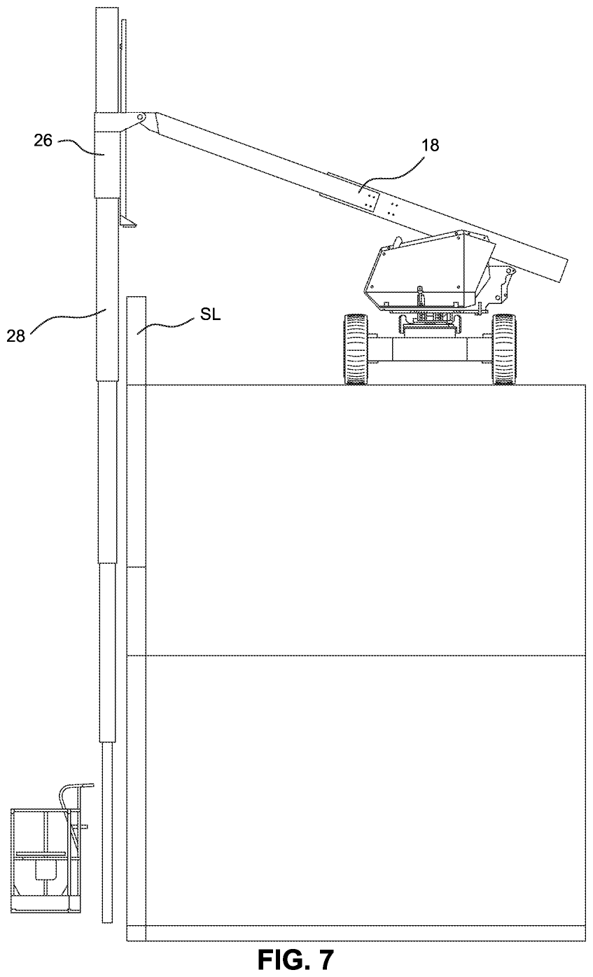

The below grade access platform machine of the described embodiments is particularly useful for trench shoring. With reference to FIG. 7, the tower boom 18 is pivotable via the lift cylinder 36 to a raised position positioning the mast mounting bracket 26 of the mast boom assembly 24 up and over a potentially raised shoreline SL (represented schematically in FIG. 7). This feature provides added functionality regardless of ground conditions for trench shoring.

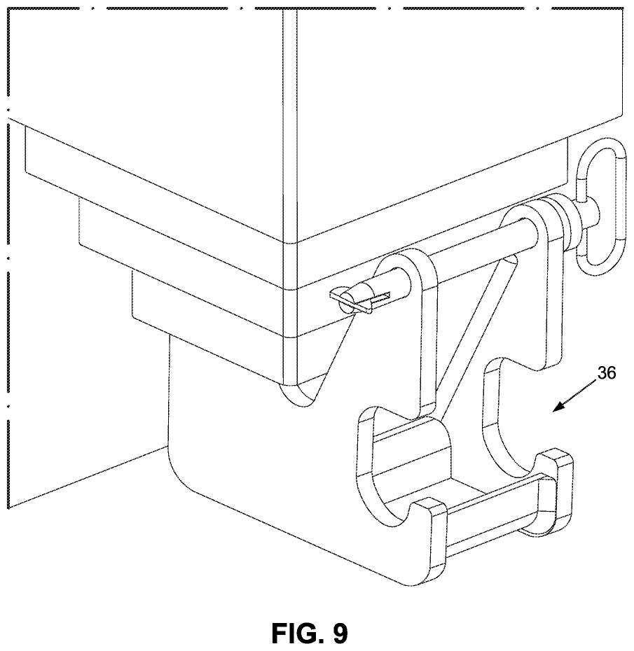

The platform 34 may be secured to the mast boom 28 using any known configuration. FIG. 9 shows an exemplary connecting hook assembly 36 for supporting the platform 34. With the connecting hook assembly 36, the platform and a platform support can be removed and replaced by hooks or the like for lowering equipment. The connecting hook assembly 36 has been strengthened for this application in order to allow for higher platform loads and larger platforms. Moreover, since leveling of the mast occurs at the tower-mast interface, the connecting hook assembly 36 may be rigidly connected to the mast boom assembly 24.

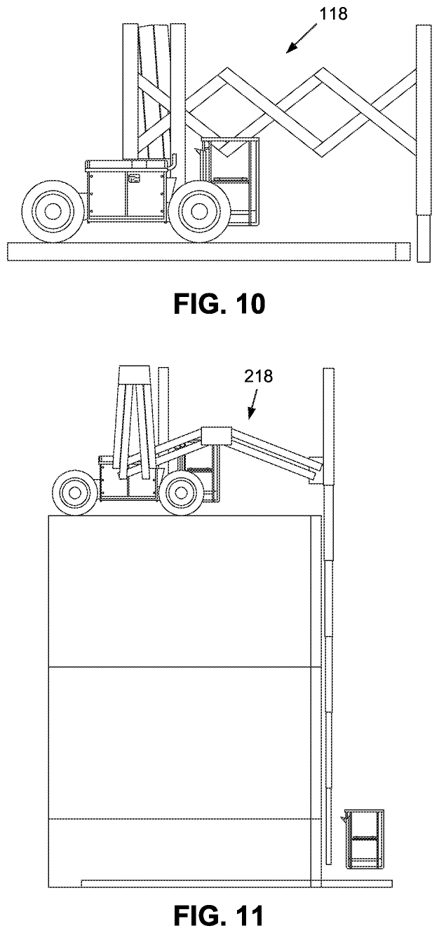

FIGS. 10 and 11 show exemplary variations of the tower boom including a scissor assembly 118 (FIG. 10) and an articulating boom 218 (FIG. 11). The articulating boom 218 may use parallelogram links as shown so that the mast boom assembly maintains its orientation during extension and retraction of the articulating boom 218.

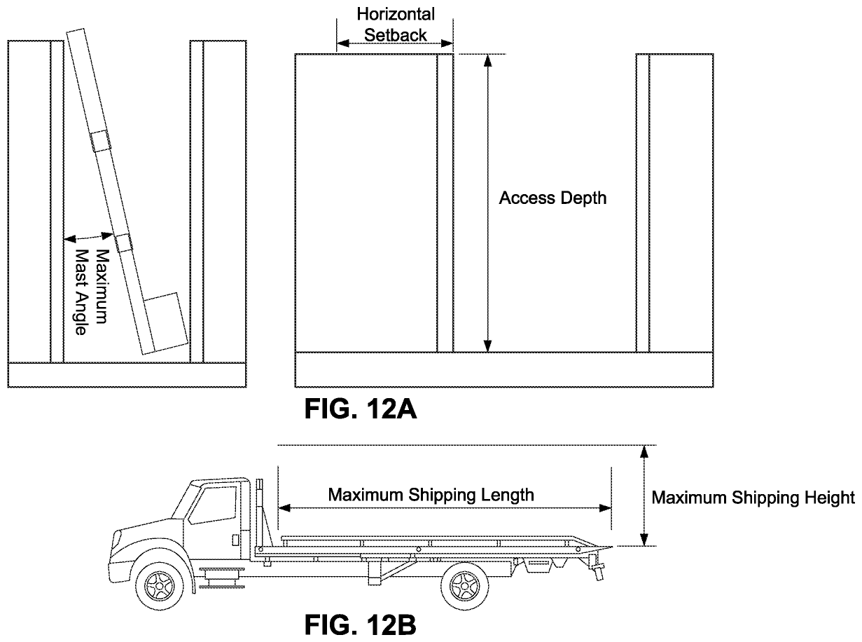

With reference to FIGS. 12A and 12B, design targets for the below grade access platform machine include an access depth of 24 feet, a horizontal setback of 8 feet, a platform capacity of 500 pounds, a platform size of 30″×48″, a maximum mast angle (front-rear) of 5°, and a maximum side slope of 10°. With regard to maximum side slope, the side slope is the slope of the ground relative to the trench. Assume a coordinate system where the X-axis lies perpendicular to the trench wall, the Y-axis runs parallel to the trench, and the Z-axis is vertical with respect to gravity. Any slope that is rotated around the Y-axis can be corrected for with tower lift and mast level. Side slope would represent rotation of the ground plane around the X-axis; in other words, ground slope deviating from parallel with the Y-axis.

It is desirable to design the machine such that it may be shipped (in the shipping position) using a rollback carrier, where a maximum shipping height is 9.5 feet, a maximum shipping length is 19 feet, and a maximum curb weight is 12,000 pounds. Ideally, the machine may be sized such that two machines can be shipped per rollback carrier with a maximum shipping length of 9.5 feet and a maximum curb weight of 6000 pounds. The maximum mast angle may be 15° with a platform size of 36″×96″.

Other features may be associated with the below grade access platform machine 10 including a platform-mounted pump or hosing through the mast and boom for evacuating water out of the trench. The machine may also include extension cord reels, work lights, air compressors, generators, etc. to increase functionality of the machine. Additionally, pairs of machines 10 can be wirelessly connected (via Bluetooth or the like) to allow loads to be simultaneously lowered.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A below grade access platform machine comprising:
a chassis;
a turntable mounted on the chassis;
a tower boom pivotably coupled with the turntable;
a mast boom assembly coupled with the tower boom, the mast boom assembly including a mast mounting bracket coupled pivotably to the tower boom and a mast boom displaceable vertically in the mast mounting bracket; and
a platform coupled with the mast boom and displaceable with the mast boom between a level position essentially level with the chassis and a lowered position below the chassis.

2. A below grade access platform machine according to claim 1, wherein the mast boom is telescopic.

3. A below grade access platform machine according to claim 2, wherein the mast boom includes a base section connected and displaceable relative to the mast mounting bracket and at least one telescoping section, wherein the platform is coupled with the telescoping section.

4. A below grade access platform machine according to claim 2, wherein the tower boom is telescopic.

5. A below grade access platform machine according to claim 4, wherein the tower boom comprises a home section pivotably coupled with the turntable and an extension section, wherein the mast boom assembly is coupled with the extension section.

6. A below grade access platform machine according to claim 1, wherein the turntable is mounted for rotation on the chassis.

7. A below grade access platform machine according to claim 6, wherein the turntable is rotatable through 360° on the chassis.

8. A below grade access platform machine according to claim 1, wherein the mast boom assembly is pivotable relative to the tower boom via the mast mounting bracket into a shipping position in which the mast boom is essentially parallel to the tower boom and overlays the tower boom.

9. A below grade access platform machine according to claim 1, further comprising a lift cylinder connected between the turntable and the tower boom, the lift cylinder effecting pivoting of the tower boom relative to the turntable between a shipping position and raised position.

10. A below grade access platform machine according to claim 1, wherein the tower boom comprises a scissor assembly.

11. A below grade access platform machine according to claim 1, wherein the tower boom comprises an articulating boom.

12. A below grade access platform machine comprising:
a chassis;
a turntable mounted for rotation on the chassis;
a tower boom pivotably coupled with the turntable, the tower boom being pivotable between a shipping position oriented below horizontal to a raised position oriented above horizontal, wherein the tower boom is linearly extendable;
a mast boom assembly coupled with the tower boom, the mast boom assembly including a mast mounting bracket coupled pivotably to the tower boom and a mast boom displaceable vertically in the mast mounting bracket, wherein the mast boom is telescopic; and
a platform coupled with the mast boom and displaceable with the mast boom to a lowered position below the chassis.

13. A below grade access platform machine according to claim 12, wherein the mast boom includes a base section connected and displaceable relative to the mast mounting bracket and at least one telescoping section, wherein the platform is coupled with the telescoping section.

14. A below grade access platform machine according to claim 12, wherein the tower boom comprises a home section pivotably coupled with the turntable and an extension section, wherein the mast boom assembly is coupled with the extension section.

15. A below grade access platform machine according to claim 12, wherein the turntable is rotatable through 360° on the chassis.

16. A below grade access platform machine according to claim 12, wherein the mast boom assembly is pivotable relative to the tower boom via the mast mounting bracket into an overlay position in which the mast boom is essentially parallel to the tower boom in the shipping position and overlays the tower boom.

17. A below grade access platform machine according to claim 12, further comprising a lift cylinder connected between the turntable and the tower boom, the lift cylinder effecting pivoting of the tower boom relative to the turntable between the shipping position and the raised position.

18. A below grade access platform machine according to claim 12, wherein the tower boom comprises a scissor assembly.

19. A below grade access platform machine according to claim 12, wherein the tower boom comprises an articulating boom.
